(19) United States
(12) Patent Application Publication
(10) Pub. No.: US 2019/0059126 A1
(43) Pub. Date: Feb. 21, 2019

(54) RADIO TERMINAL AND RELAY NODE

(71) Applicant: KYOCERA CORPORATION, Kyoto (JP)

(72) Inventors: Kugo MORITA, Yokohama-shi (JP); Hiroyuki URABAYASHI, Yokohama-shi (JP)

(73) Assignee: KYOCERA CORPORATION, Kyoto (JP)

(21) Appl. No.: 16/168,908

(22) Filed: Oct. 24, 2018

Related U.S. Application Data
(63) Continuation of application No. PCT/JP2017/016499, filed on Apr. 26, 2017.

(30) Foreign Application Priority Data
Apr. 26, 2016 (JP) 2016-088633

(51) Int. Cl. H04W 76/18; H04W 48/12; H04W 36/38; H04W 36/30; H04B 17/318

(52) U.S. Cl. CPC H04W 76/18; H04W 48/12; H04B 17/318; H04W 36/30; H04W 36/385

(57) ABSTRACT

A radio terminal according to one embodiment comprises a receiver configured to receive from a relay node a connection prohibition message for restricting a cell to be connected at a predetermined frequency. The connection prohibition message is a message for prohibiting transmission of a connection request at the predetermined frequency.

### CROSS-REFERENCE TO RELATED APPLICATION

The present application is a continuation based on PCT Application No. PCT/JP2017/016499 filed on Apr. 26, 2017, which claims the benefit of Japanese Patent Application No. 2016-088633 (filed on Apr. 26, 2016). The content of which is incorporated by reference herein in their entirety.

### FIELD

The present disclosure relates to a radio terminal and a relay node.

### BACKGROUND

In 3GPP (3rd Generation Partnership Project) which is a project aiming to standardize a mobile communication system, specifications of a relay node (RN) have been designed (see Non Patent Document 1).

On behalf of a base station, the relay node having a functionality of the base station can provide a service to a radio terminal. Currently, the relay node is used mainly to compensate a coverage of the base station.

### PRIOR ART DOCUMENT

### Non-Patent Document

Non Patent Document 1: 3GPP Technical Specification “TS 36.300 V13.2.0” Jan. 13, 2016

### SUMMARY

A radio terminal according to one embodiment comprises a receiver configured to receive from a relay node a connection prohibition message for restricting a cell to be connected at a predetermined frequency. The connection prohibition message is a message for prohibiting transmission of a connection request at the predetermined frequency.

A relay node according to one embodiment comprises a transmitter configured to transmit to a radio terminal a connection prohibition message for restricting a cell to be connected at a predetermined frequency. The connection prohibition message is a message for prohibiting transmission of a connection request at the predetermined frequency.

A relay node according to one embodiment comprises a controller configured to obtain information on a radio terminal accommodated in a moving body in which the relay node is installed; and a transmitter configured to transmit to a base station the information on the radio terminal to prohibit the radio terminal from connecting to a cell to which the relay node is scheduled to connect.

A radio terminal according to one embodiment comprises a receiver configured to receive a connection prohibition message from a relay node. The connection prohibition message includes cell information on a scheduled cell being a cell to which the relay node is scheduled to connect and being a cell for which a connection of the radio terminal is prohibited.

A relay node according to one embodiment comprise a transmitter configured to transmit a connection prohibition message to a radio terminal. The connection prohibition message includes cell information on a scheduled cell being a cell to which the relay node is scheduled to connect and being a cell for which a connection of the radio terminal is prohibited

### BRIEF DESCRIPTION OF THE DRAWINGS

FIG. 1 is a diagram illustrating a configuration of an LTE system.

FIG. 2 is a protocol stack diagram of a radio interface in the LTE system.

FIG. 3 is a protocol stack diagram of a radio interface in the LTE system.

FIG. 4 is a configuration diagram of a radio frame used in an LTE system.

FIG. 5 is a block diagram of a UE 100.

FIG. 6 is a block diagram of an eNB 200.

FIG. 7 is a block diagram of an RN 500.

FIG. 8 is a diagram for describing an operation environment according to a first embodiment.

FIG. 9 is a sequence diagram for describing an operation according to a first embodiment.

FIG. 10 is a diagram for describing a first modification of the first embodiment.

FIG. 11 is a diagram for describing a second modification of the first embodiment.

FIG. 12 is a diagram for describing a third modification of the first embodiment.

FIG. 13 is a diagram for describing a second embodiment.

FIG. 14 is a diagram for describing another embodiment.

### DESCRIPTION OF THE EMBODIMENT

[Overview of Embodiment]

In recent years, it has been proposed to install a relay node in a moving body (for example, a train) accommodating a plurality of radio terminals. When the relay node executes communication with a base station on behalf of the plurality of radio terminals while the moving body is traveling, a resource use efficiency is improved.

However, since the relay node and the plurality of radio terminals move together, there is a possibility that the plurality of radio terminals accommodated in the moving body also are connected to the base station to which the relay node is connected.

A radio terminal according to one embodiment may comprises a receiver configured to receive from a relay node a connection prohibition message for restricting a cell to be connected at a predetermined frequency. The connection prohibition message may be a message for prohibiting transmission of a connection request at the predetermined frequency.

The predetermined frequency may be a frequency at which a cell to which the relay node is scheduled to connect or a cell to which the relay node is connected is operated.

A relay node according to one embodiment may comprises a transmitter configured to transmit to a radio terminal a connection prohibition message for restricting a cell to be connected at a predetermined frequency. The connection prohibition message may be a message for prohibiting transmission of a connection request at the predetermined frequency.

The predetermined frequency may be a frequency at which a cell to which the relay node is scheduled to connect or a cell to which the relay node is connected is operated.

A relay node according to one embodiment may comprises a controller configured to obtain information on a radio terminal accommodated in a moving body in which the relay node is installed; and a transmitter configured to transmit to a base station the information on the radio terminal to prohibit the radio terminal from connecting to a cell to which the relay node is scheduled to connect.

A radio terminal according to one embodiment may comprises a receiver configured to receive a connection prohibition message from a relay node. The connection prohibition message may include cell information on a scheduled cell being a cell to which the relay node is scheduled to connect and being a cell for which a connection of the radio terminal is prohibited and a cell.

The cell information may include at least one of an identifier of the scheduled cell and information on a frequency at which the scheduled cell is operated.

The cell information may include information on a period during which connection of the radio terminal is prohibited.

The radio terminal may further comprise a transmitter configured to transmit a connection request to the relay node. The receiver may receive, after transmitting the connection request, the connection prohibition message transmitted by unicast from the relay node.

The radio terminal may further comprise a controller configured to cancel transmission of a measurement report including a measurement result about a reception level of a radio signal from the scheduled cell.

A relay node according to one embodiment may comprise a transmitter configured to transmit a connection prohibition message to a radio terminal. The connection prohibition message may include cell information on a scheduled cell being a cell to which the relay node is scheduled to connect and being a cell for which a connection of the radio terminal is prohibited.

The cell information may include at least one of an identifier of the scheduled cell and information on a frequency at which the scheduled cell is operated.

The cell information may include information on a period during which connection of the radio terminal is prohibited.

The relay node may further comprise a receiver configured to receive a connection request from the radio terminal. The transmitter may transmit, after receiving the connection request, the connection prohibition message by unicast to the radio terminal.

The relay node may further comprise a receiver configured to receive from the radio terminal a measurement report including a measurement result about a reception level of a radio signal from the scheduled cell; and a controller configured to cancel the transmission of a handover request to the scheduled cell.

[Overview of system]

(Mobile Communication System)

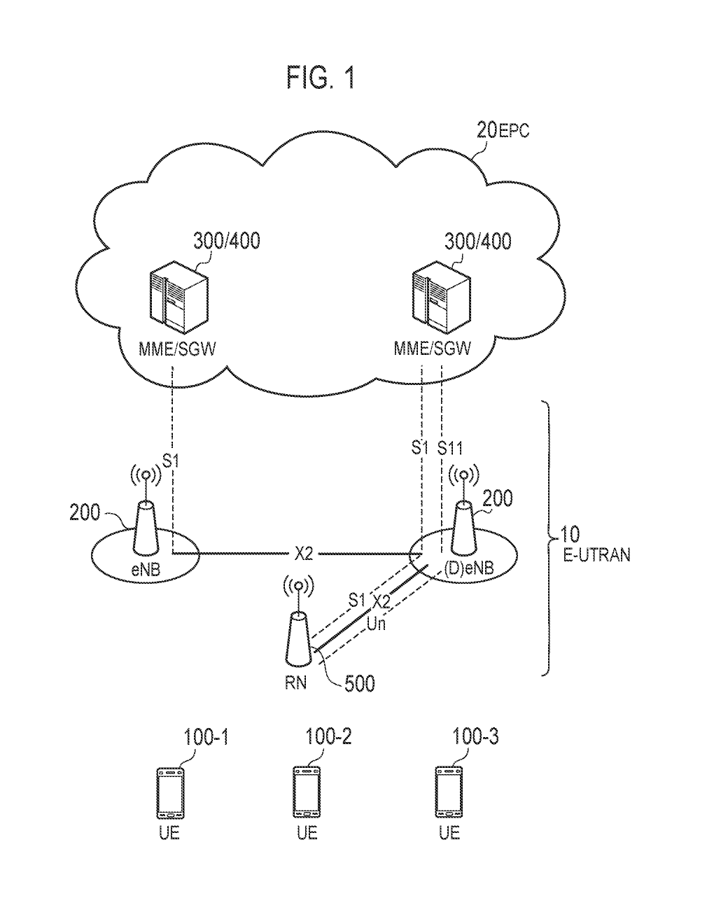

Hereafter, a Long Term Evolution (LTE) system that is a mobile communication system according to the embodiment will be described. FIG. 1 is a diagram illustrating a configuration of a Long Term Evolution (LTE) system.

As illustrated in FIG. 1, the LTE system includes a User Equipment (UE) 100, an Evolved-Universal Terrestrial Radio Access Network (E-UTRAN) 10, and an Evolved Packet Core (EPC) 20.

The UE 100 corresponds to a radio terminal. The UE 100 is a mobile communication apparatus. The UE 100 can perform radio communication with a cell (later described eNB 200 or RN 500).

The E-UTRAN 10 corresponds to a radio access network. The E-UTRAN 10 includes an evolved Node-B (eNB) 200 and a Relay Node (RN) 500.

The eNB 200 corresponds to a base station. The eNBs 200 are connected to each other via an X2 interface.

The eNB 200 manages one or a plurality of cells. The eNB 200 performs radio communication with the UE 100 that has established connection with cells managed by the eNB 200. The eNB 200 has a radio resource management (RRM) function, a routing function of user data (hereinafter, simply referred to as “data”), a measurement control function for mobility control and scheduling, and the like. The “cell” is used as a term indicating the minimum unit of a radio communication area. The “cell” is also used as a term indicating a function of performing radio communication with the UE 100.

The RN 500 corresponds to a relay device. The RN 500 can relay data of the UE 100 between the UE 100 and the eNB 200. The RN 500 is wirelessly connected to the eNB 200 via a Un interface. The eNB 200 to be connected to the RN 500 for the relay has a function of serving the RN 500. Such an eNB 200 is referred to as a Donor eNB (DeNB).

The RN 500 corresponds to a relay node (relay device). The RN 500 can communicate with the UE 100 on behalf of the eNB 200. The RN 500 supports the functionality of the eNB 200. Therefore, the RN 500 may terminate the radio protocol for 51 and X2 interfaces and an E-UTRA (Evolved Universal Terrestrial Radio Access) radio interface.

An 51 interface passing through the (D)eNB 200 may be established between the RN 500 and an MME 300/SGW 400. That is, the RN 500 may be connected to the MME 300/SGW 400 via the 51 interface. The RN 500 may communicate with the MME 300/SGW 400 via the 51 interface. An X2 interface may be established between the RN 500 and the eNB 200 via the eNB (DeNB) 200. That is, the RN 500 may be connected to the eNB 200 via the X2 interface. The RN 500 may communicate with the eNB 200 via the X2 interface.

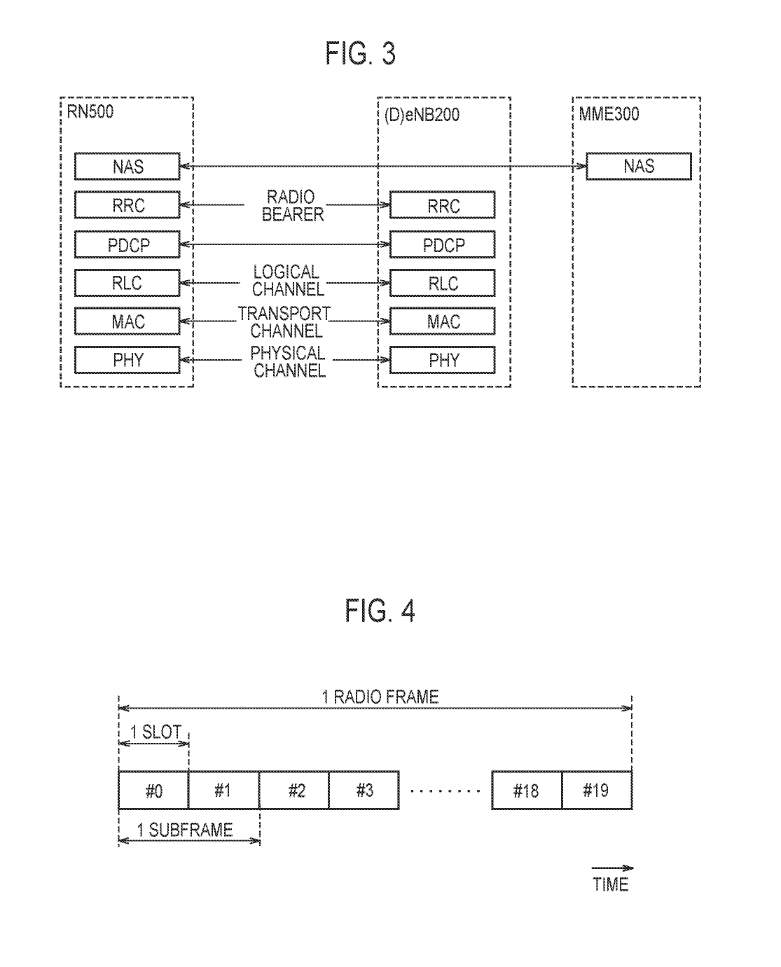

Further, the RN 500 also supports a part (subset) of the functionality of the UE 100. The RN 500 includes a protocol for a radio interface described later, for example, to be wirelessly connected to the eNB 200 (see FIG. 3).

The EPC 20 corresponds to a core network. The EPC 20 may constitute a network together with the E-UTRAN 10. The EPC 20 includes an MME (Mobility Management Entity) 300 and an SGW (Serving Gateway) 400.

The MME 300 performs, for example, various kinds of mobility control for the UE 100. The SGW 400 performs, for example, data transfer control. The MME 300 and the SGW 400 are connected to the eNB 200 via a 51 interface. The MME 300 and the SGW 400 may be connected to the RN 500 via the 51 interface.

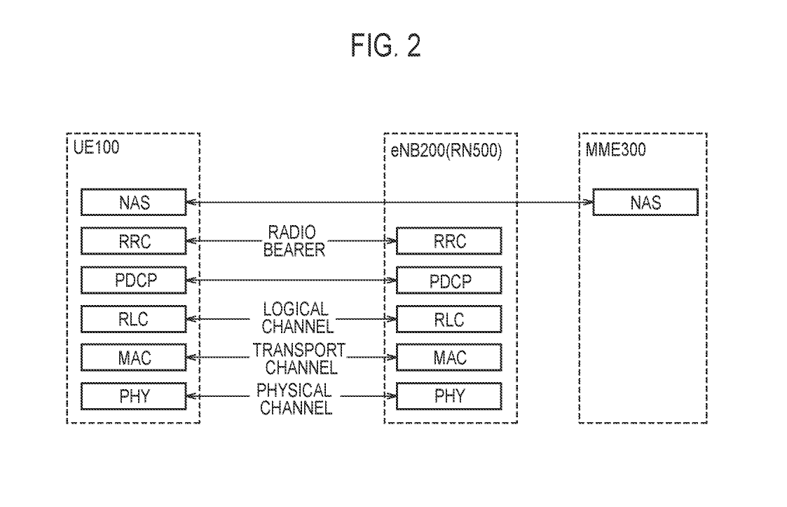

FIG. 2 and FIG. 3 are diagrams illustrating protocol stack of a radio interface in the LTE system. FIG. 2 illustrates a protocol stack diagram of the radio interface between the UE 100 and the eNB 200. FIG. 3 illustrates a protocol stack diagram of the radio interface between the RN 500 and the eNB 200.

As illustrated in FIG. 2 and FIG. 3, a radio interface protocol is separated into first to third layers of an Open Systems Interconnection (OSI) reference model. The first layer is a physical (PHY) layer. The second layer includes a Medium Access Control (MAC) layer, a Radio Link Control (RLC) layer, and a Packet Data Convergence Protocol (PDCP) layer. The third layer includes a Radio Resource Control (RRC) layer.

The physical layer performs encoding/decoding, modulation/demodulation, antenna mapping/demapping, and resource mapping/demapping. Between the physical layer of the UE 100 (RN 500) and the physical layer of the eNB 200, data and control signal are transferred via a physical channel.

The MAC layer performs data priority control, retransmission processing using a hybrid automatic repeat request (ARQ) (HARQ), a random access procedure, and the like. Between the MAC layer of the UE 100 (RN 500) and the MAC layer of the eNB 200, data and control signal are transferred via a transport channel. The MAC layer of the eNB 200 includes a scheduler (MAC scheduler). The scheduler decides a transport format (transport block size and modulation and coding schemes (MCS)) of uplink and downlink, and a resource block to be allocated to the UE 100.

The RLC layer transfers data to an RLC layer on a reception side using the functions of the MAC layer and the physical layer. Between the RLC layer of the UE 100 (RN 500) and the RLC layer of the eNB 200, data and control information are transferred via a logical channel.

The PDCP layer performs header compression/decompression, and encryption/decryption.

The RRC layer is defined only in a control plane handling control signal. Between the RRC layer of the UE 100 (RN 500) and the RRC layer of the eNB 200, messages (RRC messages) for various configurations are transferred. The RRC layer controls the logical channel, the transport channel, and the physical channel in response to establishment, re-establishment, and release of a radio bearer. If there is connection (RRC connection) between the RRC of the UE 100 (RN 500) and the RRC of the eNB 200, the UE 100 (RN 500) is in an RRC connected state. If there is not a connection (RRC connection) between the RRC of the UE 100 (RN 500) and the RRC of the eNB 200, the UE 100 (RN 500) is in an RRC idle state.

A non-access stratum (NAS) layer located above the RRC layer performs, for example, session management, mobility management, and the like.

FIG. 4 is a configuration diagram of a radio frame used in the LTE system. In the LTE system, Orthogonal Frequency Division Multiple Access (OFDMA) is applied to downlink. In the LTE system, Single Carrier Frequency Division Multiple Access (SC-FDMA) is applied to uplink.

As illustrated in FIG. 4, a radio frame is constituted by ten subframes arranged in a time direction. Each subframe is constituted by two slots arranged in the time direction. The length of each subframe is 1 ms, and the length of each slot is 0.5 ms. Each subframe includes a plurality of resource blocks (RBs) in a frequency direction. Each subframe includes a plurality of symbols in the time direction. Each resource block includes a plurality of subcarriers in the frequency direction. One resource element (RE) is constituted by one symbol and one subcarrier. Radio resources (time/frequency resources) are allocated to the UE 100. In the frequency direction, radio resources (frequency resources) are constituted by resource blocks. In the time direction, radio resources (time resources) are constituted by subframes (or slots).

In the downlink, the section of the first several symbols of each subframe is an area that can be used as a physical downlink control channel (PDCCH) for transmitting a downlink control signal. The remaining part of each subframe is an area that can be used as a physical downlink shared channel (PDSCH) for transmitting downlink data.

In the uplink, both end portions in the frequency direction in each subframe are areas usable as a Physical Uplink Control Channel (PUCCH) for transmitting an uplink control signal. The remaining part of each subframe is an area that can be used as a physical uplink shared channel (PUSCH) for transmitting uplink data.

(Radio terminal)

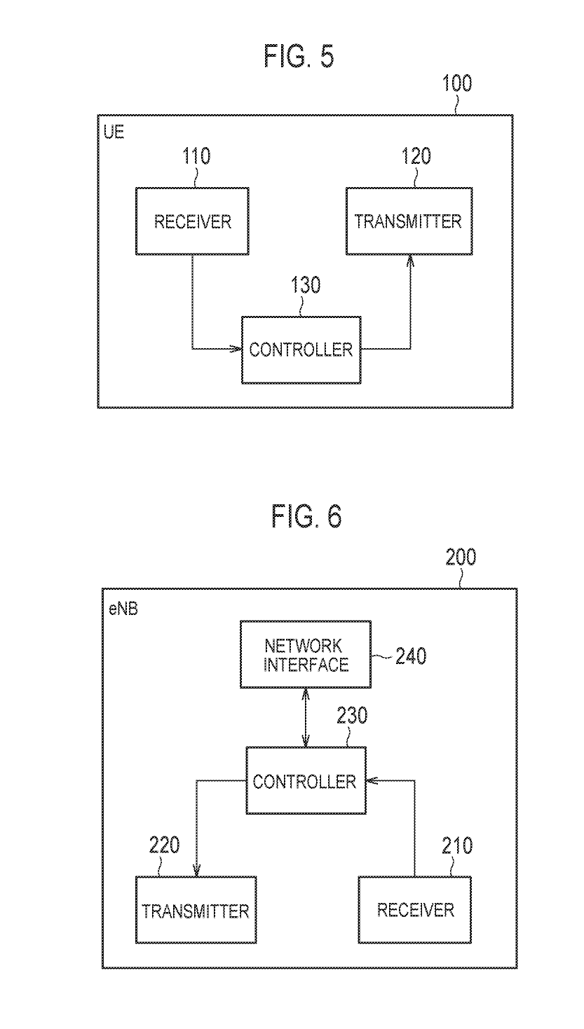

The UE 100 (radio terminal) will be described. FIG. 5 is a block diagram of the UE 100. As illustrated in FIG. 5, the UE 100 includes a receiver 110, a transmitter 120, and a controller 130. The receiver 110 and the transmitter 120 may be an integrated transceiver.

The receiver 110 performs various types of receptions under the control of the controller 130. The receiver 110 includes an antenna. The receiver 110 converts a radio signal received by the antenna into a baseband signal (reception signal). The receiver 110 outputs the baseband signal to the controller 130.

The transmitter 120 performs various types of transmissions under the control of the controller 130. The transmitter 120 includes an antenna. The transmitter 120 converts the baseband signal (transmission signal) output from the controller 130 into a radio signal. The transmitter 130 transmits the radio signal from the antenna.

The controller 130 performs various types of controls in the UE 100. The controller 130 includes a processor and a memory. The memory stores a program to be executed by the processor, and information to be used for a process by the processor. The processor includes a baseband processor and a CPU (Central Processing Unit). The baseband processor performs, for example, modulation and demodulation, as well as coding and decoding, of the baseband signal. The CPU executes a program stored in the memory to perform various types of processes. The processor may include a codec configured to perform encoding and decoding on sound and video signals. The processor executes various types of processes described later, and various types of communication protocols described above.

The UE 100 may include a GNSS (Global Navigation Satellite System) receiver unit. The GNSS receiver unit can receive a GNSS signal to obtain location information indicating a geographical location of the UE 100. The GNSS receiver unit outputs the GNSS signal to the controller 130. The UE 100 may have a GPS (Global Positioning System) function for acquiring location information of the UE 100.

For simplicity, a process executed by at least any one of the receiver 110, the transmitter 120, and the controller 130 included in the UE 100 may be described herein as a process (operation) executed by the UE 100.

(Base station)

The eNB 200 (base station) will be described. FIG. 6 is a block diagram of the eNB 200. As illustrated in FIG. 6, the eNB 200 includes a receiver 210, a transmitter 220, a controller 230, and a network interface 240. The transmitter 210 and the receiver 220 may be an integrated transceiver.

The receiver 210 performs various types of receptions under the control of the controller 230. The receiver 210 includes an antenna. The receiver 210 converts a radio signal received by the antenna into a baseband signal (reception signal). The receiver 210 outputs the baseband signal to the controller 230.

The transmitter 220 performs various types of transmissions under the control of the controller 230. The transmitter 220 includes an antenna. The transmitter 220 converts the baseband signal (transmission signal) output from the controller 230 into a radio signal. The transmitter 220 transmits the radio signal by the antenna.

The controller 230 performs various types of controls in the eNB 200. The controller 230 includes a processor and a memory. The memory stores a program to be executed by the processor, and information to be used for a process by the processor. The processor includes a baseband processor and a CPU. The baseband processor performs modulation and demodulation, coding and decoding, and the like, of the baseband signal. The CPU executes a program stored in the memory to perform various types of processes. The processor executes various types of processes described later, and various types of communication protocols described above.

The network interface 240 is connected to an adjacent eNB 200 via the X2 interface. The network interface 240 is connected to the MME 300 and the SGW 400 via the Si interface. The network interface 240 is used in communication performed on the X2 interface and communication performed on the S1 interface, for example.

For simplicity, a process executed by at least any one of the transmitter 210, the receiver 220, the controller 230, and the network interface 240 included in the eNB 200 is described herein as a process (operation) executed by the eNB 200.

(Relay node)

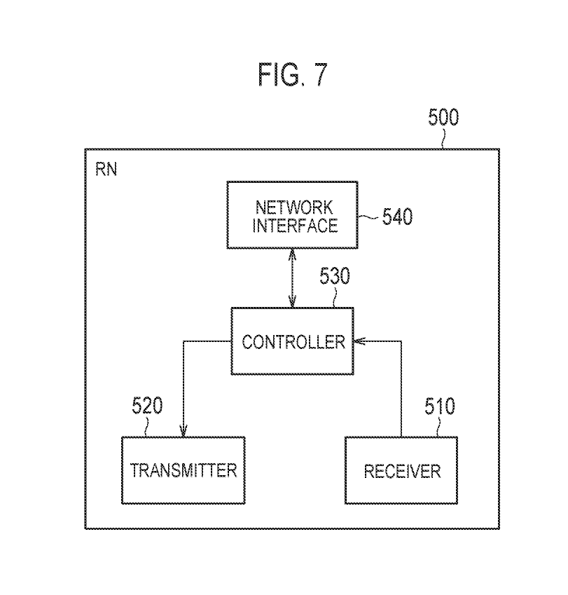

The RN 500 (relay node) will be described. FIG. 7 is a block diagram of the RN 500. As illustrated in FIG. 7, the RN 500 includes a receiver 510, a transmitter 520, a controller 530, and a network interface 540. The transmitter 510 and the receiver 520 may be an integrated transceiver. The RN 500 may not include the network interface 540.

The receiver 510 performs various types of receptions under the control of the controller 530. The receiver 510 includes an antenna. The receiver 510 converts a radio signal received by the antenna into a baseband signal (reception signal). The receiver 510 outputs the baseband signal to the controller 530.

The transmitter 520 performs various types of transmissions under the control of the controller 530. The transmitter 520 includes an antenna. The transmitter 520 converts the baseband signal (transmission signal) output from the controller 530 into a radio signal. The transmitter 520 transmits the radio signal by the antenna.

The controller 530 performs various types of controls in the RN 500. The controller 530 includes a processor and a memory. The memory stores a program to be executed by the processor, and information to be used for a process by the processor. The processor includes a baseband processor and a CPU. The baseband processor performs modulation and demodulation, coding and decoding, and the like, of the baseband signal. The CPU executes a program stored in the memory to perform various types of processes. The processor executes various types of processes described later, and various types of communication protocols described above.

The network interface 540 is connected to another node (for example, another RN 500) provided in a moving body. It is noted that the RN 500 may perform communication with other nodes by using the receiver 510 and/or the transmitter 520. For example, the RN 500, if not including the network interface 540, may perform communication with other nodes by using the receiver 510 and/or the transmitter 520.

For simplicity, a process executed by at least any one of the transmitter 510, the receiver 520, the controller 530, and the network interface 540 included in the RN 500 is described herein as a process (operation) executed by the RN 500.

### First Embodiment

(Operation Environment)

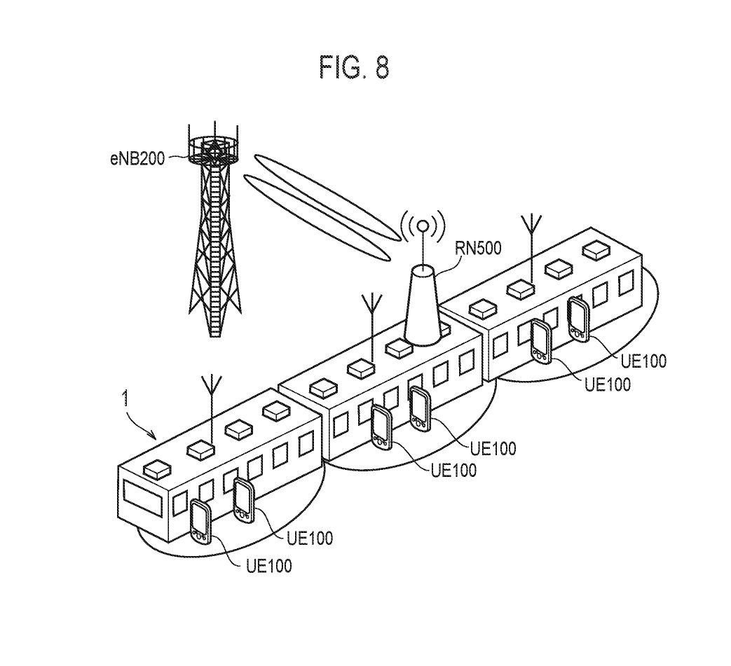

An operation environment according to a first embodiment will be described by using FIG. 8. FIG. 8 is a diagram for describing the operation environment according to the first embodiment.

As illustrated in FIG. 8, a moving body (for example, a train) 1 accommodates respective UEs 100. An RN 500 is installed in the moving body 1. Each UE 100 and the RN 500 may establish a connection (RRC connection). Each UE 100 may be in the RRC connected state to the RN 500. Each UE 100 and the RN 500 may not establish the connection (RRC connection). Each UE 100 may be in an RRC idle state to the RN 500. Each UE 100 may establish the connection (RRC connection) with the RN 500, where necessary.

The RN 500 establishes a connection (RRC connection) with an eNB 200 (for example, macro eNB). For example, the RN 500 may execute communication with the eNB 200 by using a frequency in the 4 GHz band. On the other hand, the RN 500 may execute communication with the UE 100 by using, for example, at least one of the 4 GHz band, the 30 GHz band, and the 70 GHz band.

The eNB 200 is, for example, an eNB installed around a trajectory (for example, a railway) through which the moving body 1 passes.

The moving body 1 may move at a high speed. For example, the moving body 1 may move at a speed equal to or higher than a threshold value (for example, 500 km/h). Therefore, each UE 100 and the RN 500 can move at a high speed (at a speed equal to or higher than a threshold value) according to the movement of the moving body 1.

(Operation According to First Embodiment)

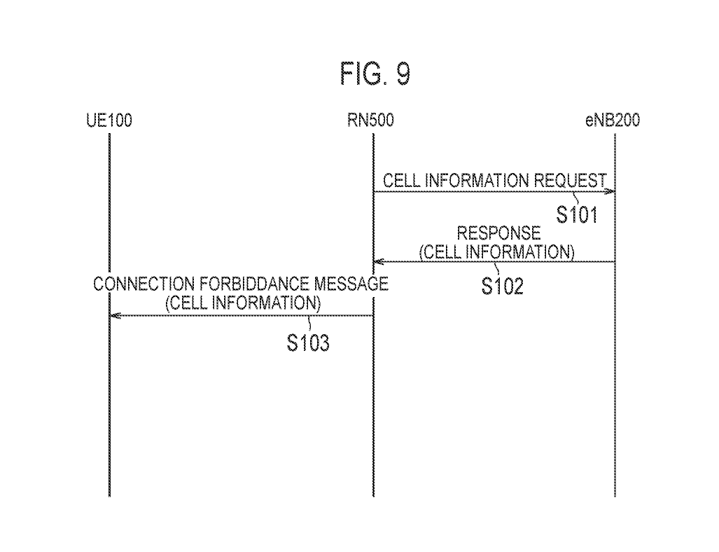

Next, an operation according to the first embodiment will be described by using FIG. 9. FIG. 9 is a sequence diagram for describing the operation according to the first embodiment.

As illustrated in FIG. 9, in step S101, the RN 500 may transmit a cell information request (Cell information request) to the eNB 200.

The RN 500 may transmit the cell information request to the eNB 200 before the moving body 1 starts moving. The RN 500 may transmit the cell information request to the eNB 200 after the moving body 1 starts moving.

The cell information request is information for requesting cell information on a scheduled cell. The cell information request may include information on at least one of an identifier of the RN 500, an identifier of the moving body 1, and movement information of the moving body 1 (RN 500).

The movement information may include information of at least any one of: information indicating a moving section (for example, a departure point, a through-point, an arrival point or the like) of the moving body 1 (RN 500), information indicating a movement time of the moving body 1 (RN 500), and information indicating a movement distance of the moving body 1 (RN 500).

In step S102, the eNB 200 may transmit a response to the cell information request, to the RN 500.

The eNB 200 may transmit a response, in response to receiving the cell information request. The eNB 200 may include previously held cell information, into the response. The eNB 200 may generate the cell information in response to receiving the cell information request.

The eNB 200 may inquire of a network device the cell information. The eNB 200 may include information included in the cell information request, into an inquiry message. The network device may be provided in the EPC 20. The network device may be provided in an external network. In response to receiving the inquiry message from the eNB 200, the network device may transmit a response message including the cell information (first cell information) to the eNB 200.

The RN 500 receives the cell information (first cell information) from the eNB 200. The cell information includes information on the scheduled cell. The scheduled cell is a cell to which the RN 500 is scheduled to connect. Specifically, the scheduled cell is a cell managed by the eNB 200 (scheduled eNB 200) installed along a movement path (for example, a railway) of the moving body 1.

The cell information may include, for example, at least one of (a list of) identifiers of the scheduled cell and a frequency at which the scheduled cell is operated.

The identifier of the scheduled cell may be a cell identifier (CI). The identifier of the scheduled cell may be ECGI (E-UTRAN Cell Global Identifier). The identifier of the scheduled cell may be associated with a scheduled time at which the RN 500 connects to the scheduled cell.

The information on the frequency at which the scheduled cell is operated may be the information on a frequency at which the cell managed by the scheduled eNB 200 is operated. The information on the frequency at which the scheduled cell is operated may be information on a frequency at which a cell scheduled to be actually connected is operated.

The identifier of the scheduled cell and the information on the frequency may be associated with each other.

The cell information may include an identifier of the eNB 200 configured to manage the scheduled cell. The identifier of the eNB 200 may be an eNB identifier (eNB ID) used for identifying the eNB 200 in the PLMN. The identifier of the eNB 200 may be a global eNB identifier (Global eNB ID) used for globally identifying the eNB 200.

The cell information may include information on a valid period during which the cell information (or a connection prohibition message described later) is valid. The information of the valid period may be information on a timer for measuring a period during which the cell information is valid. The information on the valid period may be information indicating an end time of the valid period.

For example, the valid period may correspond to a movement period of the moving body 1. The valid period may correspond to a scheduled connection time of each scheduled cell.

The cell information may include a first threshold value compared by the RN 500 with the movement speed. The RN 500 may transmit the connection prohibition message described later when the movement speed of the RN 500 (moving body 1) exceeds the first threshold value. The first threshold value may be a value indicating a high speed (for example, 300 km/h).

The cell information may include a second threshold value compared by the UE 100 with the movement speed. The UE 100 may determine that the cell information is valid when the movement speed of the UE 100 (moving body 1) exceeds the second threshold value. The second threshold value may be a value indicating a high speed (for example, 300 km/h). The second threshold value may be the same value as the first threshold value, or may be a value greater than the first threshold value.

The RN 500 can grasp the scheduled cell, based on the cell information.

In step S103, the RN 500 may transmit the connection prohibition message (Connection forbiddance message). The RN 500 may transmit the connection prohibition message by unicast (for example, an RRC connection reconfiguration message). The RN 500 may transmit the connection prohibition message by broadcast (SIB: SystemInformationBlock).

In the present embodiment, the connection prohibition message includes the cell information described above. The cell information included in the connection prohibition message (second cell information) may be the same cell information as that received by the RN 500 from the eNB 200. The second cell information may be a part (subset) of the cell information (first cell information) received by the RN 500 from the eNB 200.

The cell information included in the connection prohibition message is information on the scheduled cell. Here, the scheduled cell is a cell scheduled to be connected by the RN 500, and is a cell for which the connection of the UE 100 is prohibited.

The UE 100 selects a cell to which a connection request is transmitted, based on the cell information. Specifically, the UE 100 may discontinue (omit) transmitting the connection request to a cell (scheduled cell) indicated by the cell identifier included in the cell information. The UE 100 may discontinue (omit) transmitting the connection request at a frequency included in the cell information.

The UE 100 may transmit the connection request to the cell (RN 500) from which the connection prohibition message (cell information) is transmitted. The UE 100 may transmit the connection request to a cell not indicated by the cell identifier included in the cell information. That is, the UE 100 may transmit the connection request to a cell different from the scheduled cell. This is because a radio resource used by the UE 100 does not conflict with the radio resource used by the RN 500.

The UE 100 may discontinue (omit) transmitting the connection request to the scheduled cell only if the cell information (or the connection prohibition message) is valid. If the cell information is invalid, the UE 100 may transmit the connection request to the scheduled cell.

The UE 100 may determine whether or not the cell information (or the connection prohibition message) is valid, based on the information on the above-described valid period included in the cell information. The UE 100 may transmit the connection request to the scheduled cell if the cell information is invalid (if the valid period of the cell information has expired). If the cell identifier and the scheduled time at which the RN 500 is scheduled to connect to the scheduled cell are associated, the UE 100 may determine whether or not to transmit the connection request for each cell identifier. For example, if leaving the moving body 1 (for example, if a user gets off the train at an unscheduled station), the UE 100 may transmit, after the scheduled time has elapsed, the connection request to the cell indicated by the cell identifier associated with the elapsed scheduled time.

The UE 100 may determine whether or not to transmit the connection request to the scheduled cell, according to the movement speed of the UE 100 (moving body 1). If the movement speed of the UE 100 is less than the second threshold value, the UE 100 may transmit the connection request to the scheduled cell. If the movement speed of the UE 100 is equal to or higher than the second threshold value, the UE 100 does not transmit the connection request to the scheduled cell (discontinuation of transmission of the connection request).

The UE 100 may calculate the movement speed, based on the location information on the UE 100. The UE 100 may acquire the location information by a GNSS receiver. If the UE 100 is provided with an acceleration sensor, the UE 100 may calculate the movement speed by using the acceleration sensor.

The UE 100 may execute a cell (re)selection, based on the cell information. The UE 100 may lower the priority of selecting the scheduled cell.

The UE 100 (prohibited UE 100) for which the connection to the scheduled cell is prohibited may be all of the UEs 100 accommodated in the moving body 1. The prohibited UE 100 may be prohibited from connecting to the scheduled cell regardless of whether or not the prohibited UE 100 is connected to the RN 500. On the other hand, the UE 100 not accommodated in the moving body 1 may not need to be prohibited from connecting to the scheduled cell. Therefore, the UE 100 may transmit the connection request to the scheduled cell.

The prohibited UE 100 may be the UE 100 to be connected to the RN 500. For example, the UE 100 not capable of connecting to the RN 500 may not need to be prohibited from connecting to the scheduled cell even if the UE 100 is not accommodated in the moving body 1. Therefore, the UE 100 may transmit the connection request to the scheduled cell.

The connection request may be a message transmitted from the UE 100 to the eNB 200 (RN 500) in the random access procedure. For example, the connection request may be a message 1 (Random Access Preamble). The connection request message may be a message 3 (Scheduled Transmission).

The RN 500 can connect to the cell (eNB 200) according to the cell information (first cell information) after the moving body 1 has started moving.

The RN 500 may receive updated cell information from the eNB 200 (network device) after the moving body 1 has started moving. For example, when a delay occurs in the moving body 1 due to an accident or the like, the RN 500 may request the cell information to the eNB 200 (network device).

The RN 500 itself may update the cell information. For example, the RN 500 may update the cell information by including information (the cell identifier, the frequency information or the like) on an already connected cell.

The RN 500 may transmit the connection prohibition message including the updated cell information, to the UE 100. The UE 100 may determine the cell to which the connection request is to be transmitted, based on the updated cell information. The UE 100 may discard the previous cell information.

After establishing the connection with the eNB 200, the RN 500 relays the data of the UE 100. The RN 500 can transmit (relay) the data of the UE 100 received from the eNB 200, to the UE 100. The RN 500 can transmit (relay) the data of the UE 100 received from the UE 100, to the eNB 200.

Thus, the UE 100 discontinues transmitting the connection request to a cell to which the RN 500 is scheduled to connect (or a cell to which the RN 500 is currently connecting). Therefore, it is possible to suppress the allocation of the radio resource to the UE 100 accommodated in the moving body 1 from the cell (eNB 200) to which the RN 500 is connected, and thus, the RN 500 can relay by using the sufficient radio resources.

(First Modification)

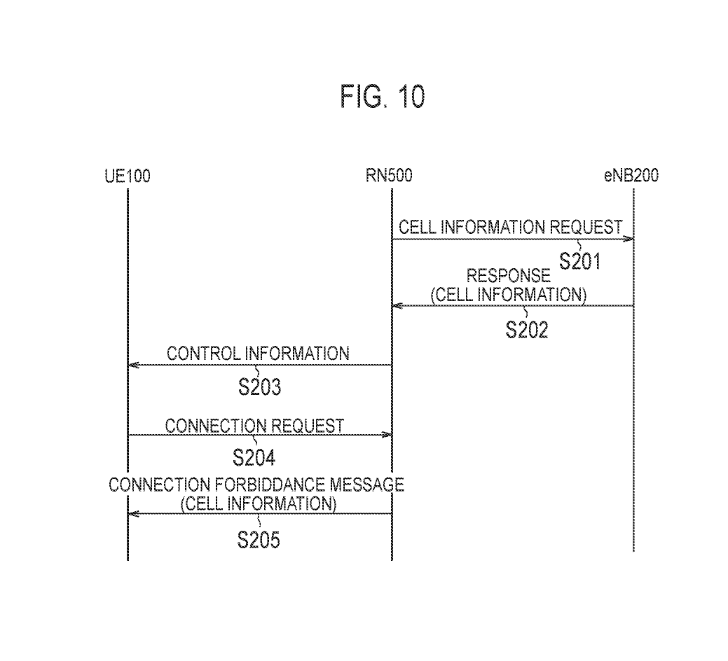

Next, a first modification of the first embodiment will be described by using FIG. 10. FIG. 10 is a diagram for describing the first modification of the first embodiment. The same contents as those described above will not be described, where appropriate.

In the present modification, the RN 500 transmits the connection prohibition message to the UE 100 that has transmitted the connection request to the RN 500

As illustrated in FIG. 10, steps S201 and S202 correspond to steps S101 and S102.

In step S203, the RN 500 transmits control information. The UE 100 receives the control information.

The RN 500 may transmit the control information at a frequency at which the scheduled cell or a cell to which the RN 500 has already connected is operated. The RN 500 may transmit the control information by broadcast.

The control information includes information for the UE 100 to connect to the RN 500. The control information may include MIB (Master Information Block). The control information may include the SIB.

In step S204, the UE 100 transmits the connection request to the RN 500, based on the control information. The UE 100 may transmit the connection request to the RN 500 at a frequency at which the control information is received.

Step S205 corresponds to step S103. The RN 500 transmits the connection prohibition message to the UE 100. After receiving the connection request, the RN 500 may transmit the connection prohibition message by unicast to the UE 100 from which the connection request is transmitted. The RN 500 may transmit the connection prohibition message to the UE 100 by, for example, an RRC reconfiguration message. After establishing the connection (RRC connection) with the UE 100, the RN 500 may transmit the connection prohibition message to the UE 100.

After transmitting the connection request, the UE 100 may receive the connection prohibition message transmitted by unicast from the RN 500.

After the UE 100 connects with the RN 500, the RN 500 may execute a procedure for allowing the UE 100 to hand over to another node (another RN 500 in the same vehicle as the UE 100) in the moving body 1. Thus, it is possible to avoid the UE 100 from starting the connection with the eNB 200 without making a connection with the RN 500 in the moving body 1.

As described above, the RN 500 can transmit the connection prohibition message, to the UE 100 that has transmitted the connection request to the RN 500. As a result, it is possible to prevent the UE 100 wishing to make a connection from connecting to the eNB 200. By transmitting the control information at the frequency at which the scheduled cell or the cell to which the RN 500 has already connected is operated, the RN 500 can prevent the UE 100 wishing to making a connection at the frequency from connecting to the eNB 200 operating the frequency. As a result, the RN 500 can relay by using sufficient radio resources.

(Second Modification)

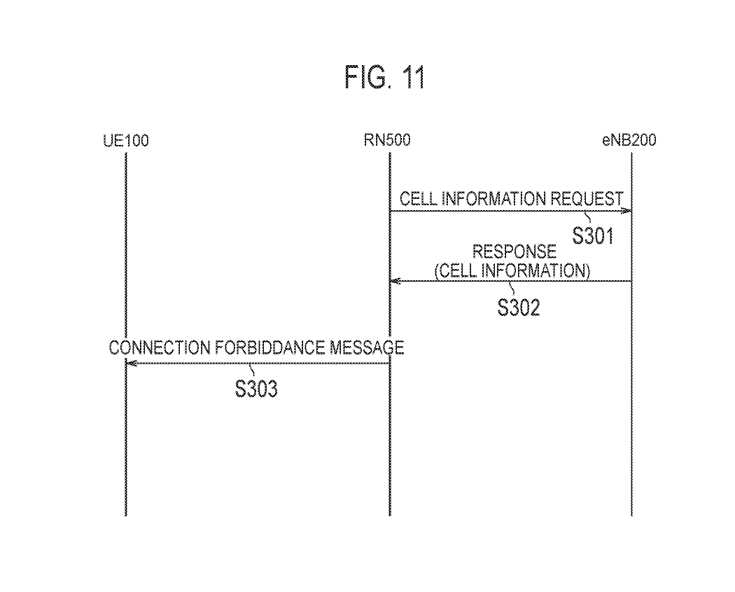

Next, a second modification of the first embodiment will be described by using FIG. 11. FIG. 11 is a diagram for describing the second modification of the first embodiment. The same contents as those described above will not be described, where appropriate.

In the present modification, the RN 500 can transmit the connection prohibition message not including the cell information.

As illustrated in FIG. 11, steps S301 and S302 correspond to steps S101 and S102.

In step S303, the RN 500 transmits the connection prohibition message at a predetermined frequency. The RN 500 may transmit the connection prohibition message by broadcast (for example, SIB). The RN 500 may transmit the connection prohibition message by unicast (for example, the RRC reconfiguration message).

The predetermined frequency is a frequency at which the scheduled cell is operated. Therefore, in the present modification, the connection prohibition message is a message for prohibiting transmission of the connection request at a predetermined cell (that is, a frequency at which the scheduled cell is operated).

The RN 500 can transmit the connection prohibition message, based on the cell information received from the eNB 200. The RN 500 may transmit the connection prohibition message at a plurality of frequencies.

The connection prohibition message may not need to contain the cell information. The connection prohibition message may include the cell information.

The UE 100 receives the connection prohibition message at a predetermined frequency. The UE 100 discontinues (omits) transmitting the connection request at the frequency at which the connection prohibition message is received (monitored). On the other hand, the UE 100 may transmit the connection request at a frequency different from the frequency at which the connection prohibition message is received (monitored).

As described above, even if not including the cell information into the connection prohibition message, the RN 500 can prevent the UE 100 from connecting to the scheduled cell.

(Third Modification)

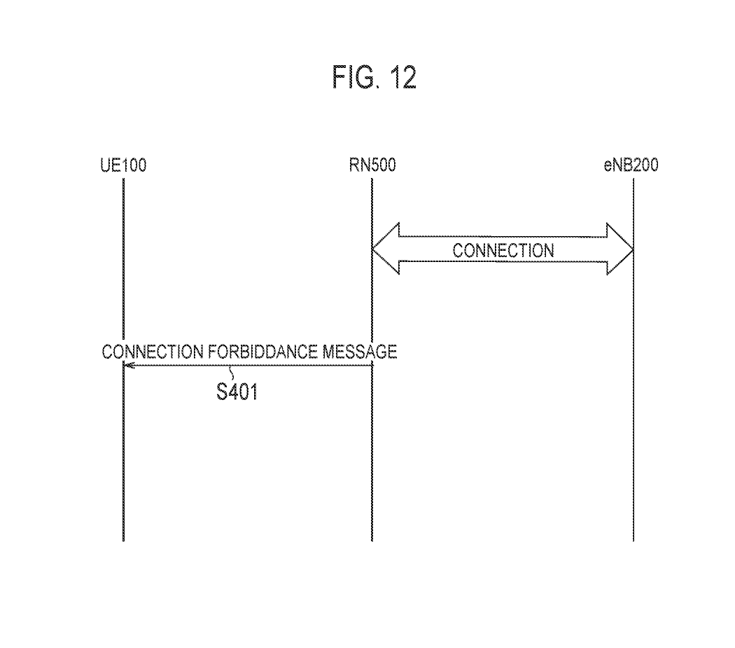

Next, a third modification of the first embodiment will be described by using FIG. 12. FIG. 12 is a diagram for describing the third modification of the first embodiment. The same contents as those described above will not be described, where appropriate.

In the present modification, the RN 500 can transmit the connection prohibition message at a frequency at which the connected cell is operated.

In an initial state of FIG. 12, the RN 500 establishes the connection (RRC connection) with the eNB 200.

In step S401, the RN 500 transmits the connection prohibition message at a predetermined frequency.

In the present modification, the predetermined frequency is a frequency at which the cell (connected cell) to which the RN 500 is connected is operated.

To transmit the connection prohibition message at the frequency at which the connected cell is operated, the RN 500 may not need to receive the cell information from the eNB 200. The RN 500 may receive the cell information from the eNB 200.

The connection prohibition message may include the cell information.

As described above, the RN 500 can prevent the UE 100 from connecting to a cell to which the RN 500 is actually connected.

### Second Embodiment

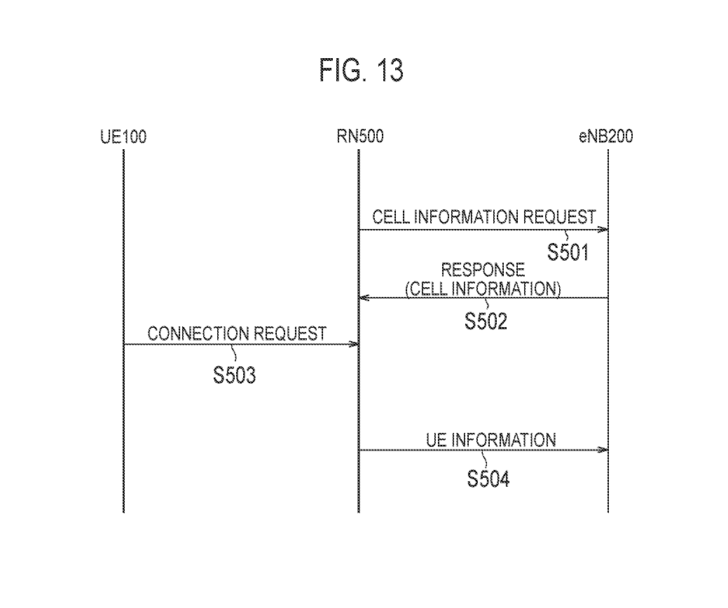

Next, a second embodiment will be described by using FIG. 13. FIG. 13 is a diagram for describing the second embodiment. The same contents as those described above will not be described, where appropriate.

In the second embodiment, the RN 500 transmits to the eNB 200 the information on the UE 100 to prohibit the UE 100 from connecting to the scheduled cell (or a connected cell to which the RN 500 is connected) to which the RN 500 is scheduled to connect.

As illustrated in FIG. 13, steps S501 and S502 correspond to steps S101 and S102.

In step S503, the UE 100 transmits the connection request to the RN 500. The RN 500 receives the connection request. The connection request may include below-described information on the UE 100.

In step S504, the RN 500 transmits the information on the UE 100 to the eNB 200 to prohibit the UE 100 from connecting to the scheduled cell (or connected cell).

In response to receiving the connection request, the RN 500 may transmit the information on the UE 100. The RN 500 may transmit the information on the UE 100 after establishing the connection with the UE 100.

The information on the UE 100 includes, for example, the identifier of the UE 100. The identifier of the UE 100 may be an identifier (RNTI: Radio Network Temporary Identifier) assigned by the RN 500. The identifier of the UE 100 may be EMSI (Encrypted Mobile Subscriber Identity).

The RN 500 may transmit the information on the UE 100 to the eNB 200 together with a message including information included in the cell information request (for example, the identifier of the RN 500). The RN 500 may transmit the information on the UE 100 to the eNB 200 together with a message including information included in the cell information (for example, information on the scheduled cell, an identifier of the eNB 200 configured to manage the scheduled cell, or the like).

When managing the scheduled cell (or the connected cell), the eNB 200 does not connect the UE 100 to the scheduled cell. When receiving the connection request from the UE 100, the eNB 200 can ignore the connection request of the UE 100. The eNB 200 may transmit a response (rejection response) to the connection request, to the UE 100.

The eNB 200 may transfer the information on the UE 100 to another eNB 200 configured to manage the scheduled cell. The eNB 200 may transfer the information on the UE 100 to the network device. The network device can transfer the information on the UE 100 to another eNB 200 configured to manage the scheduled cell. The network device may be the same as the network device configured to inquire the cell information or be different therefrom. The network device may be provided in the EPC 20. The network device may be provided in an external network.

Thus, even if transmitting the connection request to the cell to which the RN 500 is scheduled to connect (of the cell to which the RN 500 is currently connected), the UE 100 cannot connect to the cell. As a result, the RN 500 can relay by using sufficient radio resources.

### Other Embodiments

The contents of the present application are described according to each of the above-described embodiments, but it should not be understood that the discussion and the drawings constituting a part of this disclosure limit the contents of the present application. From this disclosure, various alternative embodiments, examples, and operational technologies will become apparent to those skilled in the art.

In each of the above-described embodiments, the connection prohibition message may be a message for requesting the UE 100 not to transmit the measurement report to the connection destination (for example, the RN 500). For example, the UE 100 may not need to transmit the measurement report to the RN 500 even if a trigger condition of the measurement report is satisfied during connection to the RN 500. The UE 100 may discontinue the transmission of the measurement report including the measurement result on a reception level of the radio signal (for example, a reference signal) from the scheduled cell. Therefore, the UE 100 may transmit to the RN 500 the measurement report including the measurement result on the reception level of the radio signal from the cell other than the scheduled cell.

For example, the reception level may be indicated by a received strength (RSRP: Reference Signal Received Power), a reception quality (RSRQ: Reference Signal Received Quality).

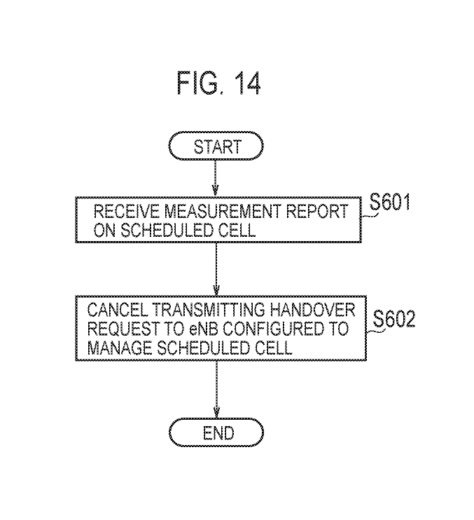

In the above description, the RN 500 transmits the control information (the connection prohibition message/the information on the UE 100) for prohibiting the connection of the UE 100, to the UE 100 or the eNB 200, but this is not limiting. As illustrated in FIG. 14, the RN 500 receives the measurement report from the UE 100 (step S 601). If the measurement report includes a measurement result about the scheduled cell, when receive the measurement report from the UE 100, the RN 500 may control so that the UE 100 does not execute the handover to the scheduled cell. For example, the RN 500 may execute a handover procedure for the UE 100 to execute a handover to the cell other than the scheduled cell. Even though the scheduled cell satisfies a condition to serve as a target cell, the RN 500 may not need to transmit the handover request to the eNB 200. That is, the RN 500 may discontinue transmitting the handover request to the scheduled cell (step S602). As a result, it is possible to prevent the UE 100 from connecting to the scheduled cell. For example, if the UE 100 is a legacy UE not capable of understanding the connection prohibition message, the RN 500 may execute this operation.

In each of the above-described embodiments, the case where one RN 500 installed in the moving body 1 communicates with the UE 100 has been described. In the moving body 1, in each of a plurality of cargos configuring the moving body 1 in which a plurality of RNs 500 may be installed, the RN 500 may be installed. For example, as illustrated in FIG. 8, an antenna of the RN 500 may be located at the top of each cargo. The UE 100 and the RN 500 located in the same cargo may execute communication (transmission and/or reception). Each RN 500 may execute communication (transmission and/or reception) with the eNB 200. Alternatively, on behalf of other RNs 500, one RN 500 (representative RN 500) may execute communication with the eNB 200. The representative RN 500 may execute communication with each of the other RNs 500 (for example, via the network interface 540).

After establishing the connection with the UE 100, the RN 500 may allow the UE 100 to execute the handover to another frequency (cell). For example, the RN 500 may execute a control for connecting to a cell (first cell) operated at a predetermined frequency (high frequency), on the UE 100 that is stopping. The RN 500 may execute a control for connecting to a cell (second cell) operated at a frequency (low frequency) lower than the predetermined frequency, on the moving UE 100.

For example, the RN 500 may regard the UE 100 located in a seat in the moving body 1 (for example, a train), as a stopping UE 100. For example, the RN 500 may regard the UE 100 located in an aisle in the moving body 1 (for example, a train), as the stopping UE 100. In an area of the seat, the RN 500 may form the first cell operated at the high frequency. In an area of the aisle, the RN 500 may form the second cell operated at the low frequency. As a result, it is possible to ensure the communication quality of the UE 100 according to the movement.

In each of the embodiments described above, the relay node may be a relay UE (ProSe UE-to Network Relay) configured to execute a relay using a proximity-based service (ProSe: Proximity-based Services).

In each of the above-described embodiments, the scheduled cell is a cell for which the connection of the UE 100 is prohibited; however, this is not limiting. The scheduled cell may be a cell in which the connection of the UE 100 is restricted. Therefore, “prohibition” may be replaced with “restriction” in the above description.

In the above description, if canceling (releasing) the prohibition (restriction) of the connection of the UE 100, the RN 500 may transmit a message for cancelling (releasing) the prohibition of the connection, similarly to the connection prohibition message. Therefore, in the above description, “prohibition” may be replaced with “cancellation (or release)”. In response to receiving the message, the UE 100 may execute an operation for connecting to the eNB 200 (cell).

If the RN 500 transmits the information on the UE 100 to the eNB 200 to cancel (release) the connection prohibition of the UE 100, the eNB 200 may execute the operation for connecting to the UE 100 from which the connection request is transmitted, based on the information.

The RN 500 may transmit, rather than the information on the UE 100, a message indicating the cancellation (or the release) of the connection of the UE 100, to the eNB 200. The eNB 200 receiving the message can discontinue the control for prohibiting the connection based on the information on the UE 100 from the RN 500.

The operation according to each of the above-described embodiments may be combined to be executed, where appropriate. In each of the above-described sequences, all of the operations may not necessarily be an essential configuration. For example, in each sequence, only some of the operations may be executed.

Although not particularly mentioned in each of the above-described embodiments, a program for causing a computer to execute each process executed by each of the above-described nodes (the UE 100, the eNB 200, the RN 500, and the network device or the like) may be provided. The program may be recorded on a computer-readable medium. If the computer-readable medium is used, it is possible to install the program in a computer. Here, the computer-readable medium recording therein the program may be a non-transitory recording medium. The non-transitory recording medium may include, but not be limited to, a recording medium such as a CD-ROM and a DVD-ROM, for example.

Alternatively, a chip may be provided which is configured by: a memory configured to store a program for executeing each process executeed by any one of the UE 100, the eNB 200, the RN 500, and the network device; and a processor configured to execute the program stored in the memory.

In the above-described embodiments, an LTE system is described as an example of the mobile communication system; however, the LTE system is not an exclusive example, and the content according to the present application may be applied to a system other than the LTE system.

1. A radio terminal, comprising:
a receiver configured to receive from a relay node a connection prohibition message for restricting a cell to be connected at a predetermined frequency, wherein
the connection prohibition message is a message for prohibiting transmission of a connection request at the predetermined frequency.

2. The radio terminal according to claim 1, wherein
the predetermined frequency is a frequency at which a cell to which the relay node is scheduled to connect or a cell to which the relay node is connected is operated.

3. A radio terminal, comprising:
a receiver configured to receive a connection prohibition message from a relay node, wherein
the connection prohibition message includes cell information on a scheduled cell being a cell to which the relay node is scheduled to connect and being a cell for which a connection of the radio terminal is prohibited.

4. The radio terminal according to claim 3, wherein
the cell information includes at least one of an identifier of the scheduled cell and information on a frequency at which the scheduled cell is operated.

5. The radio terminal according to claim 3, wherein
the cell information includes information on a period during which connection of the radio terminal is prohibited.

6. The radio terminal according to claim 3, further comprising:
a transmitter configured to transmit a connection request to the relay node, wherein
the receiver receives, after transmitting the connection request, the connection prohibition message transmitted by unicast from the relay node.

7. The radio terminal according to claim 3, further comprising:
a controller configured to cancel transmission of a measurement report including a measurement result about a reception level of a radio signal from the scheduled cell.

8. A relay node, comprising:
a transmitter configured to transmit a connection prohibition message to a radio terminal, wherein
the connection prohibition message includes cell information on a scheduled cell being a cell to which the relay node is scheduled to connect and being a cell for which a connection of the radio terminal is prohibited.

9. The relay node according to claim 8, wherein
the cell information includes at least one of an identifier of the scheduled cell and information on a frequency at which the scheduled cell is operated.

10. The relay node according to claim 8, wherein
the cell information includes information on a period during which connection of the radio terminal is prohibited.

11. The relay node according to claim 8, further comprising:
a receiver configured to receive a connection request from the radio terminal, wherein
the transmitter transmits, after receiving the connection request, the connection prohibition message by unicast to the radio terminal.

12. The relay node according to claim 8, further comprising:
a receiver configured to receive from the radio terminal a measurement report including a measurement result about a reception level of a radio signal from the scheduled cell; and
a controller configured to cancel the transmission of a handover request to the scheduled cell.
